(19) United States
(12) Patent Application Publication
(10) Pub. No.: US 2024/0289241 A1
(43) Pub. Date: Aug. 29, 2024

(54) SYSTEM AND METHOD OF EFFICIENT AND ACCURATE DATA PROCESSING PIPELINE HANG CLASSIFICATION

(71) Applicant: Intel Corporation, Santa Clara, CA (US)

(72) Inventors: Syed Ahsan, Folsom, CA (US); Michael F. Cole, Folsom, CA (US); Rupali Kumari, Malden, MA (US); Yasmine Omri, Cambridge, MA (US)

(73) Assignee: Intel Corporation, Santa Clara, CA (US)

(21) Appl. No.: 18/399,202

(22) Filed: Dec. 28, 2023

Related U.S. Application Data
(60) Provisional application No. 63/538,477, filed on Sep. 14, 2023.

(51) Int. Cl. G06F 11/22

(52) U.S. Cl. CPC G06F 11/2221; G06F 11/2273

(57) ABSTRACT

A computer-implemented system and method comprises injecting a hang of data transfer on at least one of a plurality of interfaces interconnecting simulated, emulated, or physical hardware subcomponents arranged to send or receive data transmitted between the subcomponents. The system and method also include determining activity status of data transfer at the interfaces. Then the system and method generates a hang signature to be placed in a hang signature database. The hang signature indicates the activity status of the interfaces that occur when the hang is present and the identification of the hardware subcomponent with the hang.

### CROSS-REFERENCE TO RELATED APPLICATIONS

This application claims the benefit of U.S. Provisional Patent Application No. 63/538,477, filed Sep. 14, 2023, which is incorporated herein for all purposes.

### BACKGROUND

When a data processing pipeline, such as video encoder and/or decoder hardware, becomes hung or freezes, or in other words, unresponsive due to an unrecoverable error, this is usually due to a particular subcomponent of the coding system. For example, hangs for video coding data processing pipelines can be caused by full memories, network noise, bad or incompatible programming, and so forth. However, identifying the responsible subcomponent in the pipeline after a hang occurs is a difficult task because the lack of forward progress by the responsible subcomponent usually creates a cascading hanging effect in other subcomponents. Therefore, by the time a hang condition is identified, many of the subcomponents will appear to be hung, and little information exists that can be reliably used to determine which of the many subcomponents is responsible for the hang.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an example complex hardware pipeline showing an intentionally injected hang according to at least one of the implementations herein;

FIG. 2A is schematic diagram of an example data processing system to generate a database of reference hang signatures for a data processing device according to at least one of the implementations herein;

FIG. 2B is a schematic diagram of an example data processing system to classify hangs for a data processing device according to at least one of the implementations herein;

FIG. 3 is a flow chart of an example method of generating a database of reference hang signatures for a data processing device according to at least one of the implementations herein;

FIG. 4 is a schematic flow diagram of a finite state machine to inject a hang according to at least one of the implementations herein;

FIG. 5 is a schematic flow diagram of another finite state machine to inject a hang according to at least one of the implementations herein;

FIG. 6 is a graph of example subcomponent interface control signals according to at least one of the implementations herein;

FIG. 7 is a graph of another example of subcomponent interface control signals according to at least one of the implementations herein;

FIG. 8 is yet another example of subcomponent interface control signals according to at least one of the implementations herein;

FIG. 9 is a flow chart of a method of hang classification according to at least one of the implementations herein;

FIG. 10 is an illustrative diagram of an example system;

FIG. 11 is another illustrative diagram of an example system; and

FIG. 12 illustrates an example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems unless mentioned otherwise, and may be implemented by any architecture and/or computing system for similar purposes. For instance, various architectures employing, for example, multiple integrated circuit (IC) chips and/or packages, and/or various computing devices and/or consumer electronic (CE) devices such as servers, computers, desktops, laptops, set top boxes, smartphones, and tablets, and particularly for image processing camera, camera arrays, and virtual reality (VR) or augmented reality (AR) headsets or other display devices, etc. may implement at least parts of the techniques and/or arrangements described herein. As mentioned below, the disclosed systems, methods, and devices are not limited to image processing and may be used on may other devices with integrated circuits. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof unless mentioned otherwise. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Methods, devices, apparatuses, computing platforms, media, and articles are described herein related to efficient and accurate data processing pipeline hang classification.

A number of conventional debugging techniques that exist to analyze data processing pipelines or systems are typically categorized as pre-silicon debugging and post-silicon debugging. Pre-silicon hang debugging is performed on simulations (or models) or hardware emulations, while post-silicon hang debugging occurs during testing of the manufactured physical hardware that is to be subsequently deployed.

To detect the cause of a hang in a pipeline in a conventional pre-silicon test simulation, a debug using a waveform is a common approach. This involves obtaining the waveforms of outputs or other data from hardware subcomponents or units forming a pipeline, such as a video coding pipeline, which is then analyzed manually by a user viewing the output. For emulation, this often involves the use of field-programmable gate array (FPGA) based models which requires many steps to capture a waveform and in turn large amounts of time consumption. Thus, this is a very slow process due to the use of a large model that needs manual involvement for both validation and hang testing design, flow, and arrangement.

Also, in the traditional validation approach, special test scenarios or workloads are generated to hit unique stress scenarios. But for large systems, in most cases, these test cases are not easy to establish, and in some cases, it is very complex and time consuming to generate these unique tests cases, especially when a stall or stress scenario is at the middle of a large pipeline. Due to this difficulty, it is very common for validators to waive or defer some of these cases during pre-silicon phase testing before design freeze. This results in bug escapes which get exposed in silicon, and need either a fix in the next product step or driver workaround, which is not an efficient process.

For post-silicon hang debugging, a number of techniques may be used to attempt to classify the hang. In one attempt, a conventional Visualization of Internal Signals Architecture (VISA) technique uses signals that are exposed through a physical VISA port for post silicon validation purposes. The VISA systems, however, cannot be easily modified to add testing ports to monitor the data transfer status of the various hardware components of the VISA that do not already have a VISA port at a desired location to find a hang. Thus, this VISA debug technique can be challenging and a slow process when hang conditions or failure is not easy to find through VISA signals.

In another attempt, a conventional Periodic System Management Interrupt (PSMI) capture is a conventional debug feature that allows cycle-accurate capture and replay of specific system runs. If there is hang or data corruption in silicon, this is used to capture a waveform from whichever failure is debugged. This involves a correct window for a capture and debug using the waveform to determine the root cause of the failure.

In yet another technique, and in known scan dumps, a scan chain includes all the flip-flops in an integrated circuit (IC) design. If there is any failure, especially a hang case, all the flip-flop values can be dumped at a particular steady state time using the scan feature. This involves analysis of a very high number of flip-flops in the design and a very slow process.

Another technique is to reproduce an issue in a simulation model. Here, a test in silicon first needs to be converted into a simulation friendly test, and then run in the simulation or emulation model. However, a majority of the driver tests for silicon are extremely large, and cannot be run in a simulation environment most of the time. Thus, this process also is a slow process.

Thus, the previous solutions are slow, tedious, manual, not comprehensive, and/or have less visibility and/or are error prone.

To resolve these issues, the present method and system provides a hang classification technique that indicates which subcomponents or units of a multi-subcomponent data processing device is causing the hang (or is the root-cause of the hang), and in one particular example herein, is causing hangs for video coding devices. This is accomplished by first performing a pre-silicon data collection stage that involves injecting an intentional hang at a simulated interface between simulated hardware subcomponents (or just subcomponents) of a simulated (or virtual) data processing device. Such a device may have a network of the hardware subcomponents each representing a real physical hardware subcomponent of a real physical data processing device. Each simulated subcomponent may represent a specific-function hardware subcomponent. Whether real or simulated, the interfaces interconnect the subcomponents to transfer data between the subcomponents. During the first stage, a database of hang signatures is generated by having a test unit (which can be a test bench) intentionally inject a hang at one of a number of available interfaces. The hang condition may be simulated in the network by injecting one or more long stalls on one particular selected interface in the network. It will be appreciated that the term simulated or virtual hardware as used herein may include emulated hardware when discussing hang injecting and interface monitoring processes described herein, and unless mentioned otherwise.

Once the network reaches a steady state, the data processing device is then monitored to determine the activity status at each or individual interfaces when or after the intentional hang has occurred. When the state of all interfaces in the network are read during a hang, at least a large portion or each of the interfaces should be in either a stall or starve state. A hang signature, referred to as a reference hang signature, is then formed that indicates the identification of the interface with the intentional hang and the status of each of the interfaces being monitored at the time of the hang. This may include statuses such as idle, active, stall, and starve described below. Then the process is repeated many times, such as 1000s of times or some other desired number of times, using different interfaces, workloads, and random data values (or seeds), in order to construct a reference hang signature database that stores reference hang signatures each with a different interface, workload, seed, and/or other signature parameter.

During a next stage of testing a data processing device, when a real hang occurs whether on pre-silicon or post-silicon physical devices, the state of all interfaces is read, and a corresponding generated or hidden signature is formed where the interface causing the hang is unknown at least to a machine learning (or other type) model trained to detect the interface causing the hang. The generated hang signature then may be looked up in the database to find either an exact or close match by the model. This may be performed by training the machine learning model by using the reference hang signatures in the database. The machine learning model then outputs the identification of the subcomponent with a hang, if any.

With this method, an accurate, fast, and automated hardware hang detection method is provided that is applicable for both pre-silicon and post silicon debug for hang detection. The simulated hardware infrastructure can be used to inject back-pressure (or in other words a stall) in a targeted way to find performance and functional corner case bugs. The injection is not needed at the post-silicon stage, just the monitoring of the real interfaces to detect real hangs. Also, the use of the same equipment and/or techniques alone for both pre and post silicon will reduce significant validation effort.

The system and method also provide scalable solutions for hang detection and recovery. The method can be used not only for video encoder/decoder hardware, but it can also be used in any hardware with many pipelines and cascade stages. While the method can cause a stall to create backpressure in any or individual interface during validation at a pipeline and collect performance data at different stall conditions, this is particularly true with graphics or image processing, or any other data processing device, that typically uses a same interface type or structure across many or all units in a hardware pipeline.

Otherwise, since the present method and system is able to inject an intentional hang at any interface along a pipeline as long as it has the configuration described herein, this provides significant decreases in validation effort since difficult to establish scenarios can be simulated easily with intermediate subcomponents on a pipeline. Also, this will increase the amount of difficult scenarios tested rather than skipped for efficiency purposes, thereby increasing the quality of a final product.

Specifically, the disclosed system and method may provide stall injections through generic hardware in each interface that is dedicated for pre-silicon silicon testing, which is a valuable tool for corner case design validation. The stall used to inject a hang is performed by altering interface control signals that set the interfaces in a certain data transfer states. Since the subcomponents are actually simulated during the pre-silicon testing, in reality these control signals are being routed through a testbench. Thus, it is easy to introduce stress scenarios between any selected subcomponents of the pipeline. These stress scenarios are incredibly helpful in exposing corner case control bugs, mimicking slow memory traffic which allows testing of the performance of the pipeline, but also investigating and understanding hangs that typically arise in the post-silicon stage and that are notoriously difficult to debug.

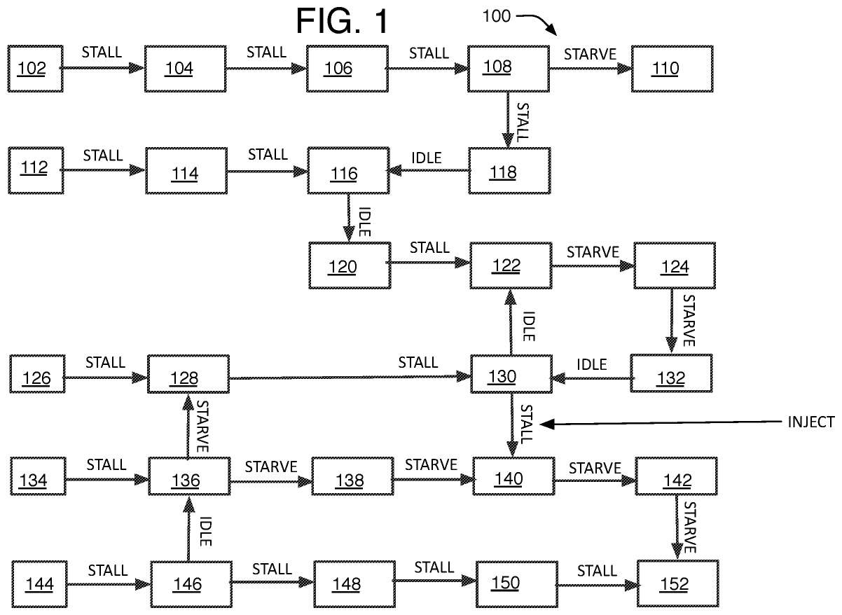

Referring to FIG. 1, a simulated image processing system or device (or pipeline) 100 may be used for pre-silicon reference hang signature database generation and then for real hang detection and identification while performing pre-silicon tests. Herein, a real hang refers to an unintentional hang versus an injected intentional hang, and whether on simulated or real hardware. The image processing device 100 may be simple or complex as shown with many (here simulated) subcomponents numbered evenly 102 to 152. The subcomponents or representative pre-silicon subcomponents may be established by register-transfer level (RTL) code, and may be run by any desired circuitry with capacity to perform the operations described herein for pre-silicon simulation or may be assigned to particular circuitry structures, such as gates of an FPGA for emulation. The series of subcomponents may be in a linear flow arrangement but otherwise can form a complex network as shown, and including recurrent loops and so forth, and is not limited as to the arrangement of subcomponents as long as data transfer interfaces provide data from one subcomponent to another. The subcomponents may be arranged to represent real, physical hardware subcomponents, such as with subcomponents for image data partitioning, transform, quantization, prediction, residual generation, and so forth for video coding as one possible example.

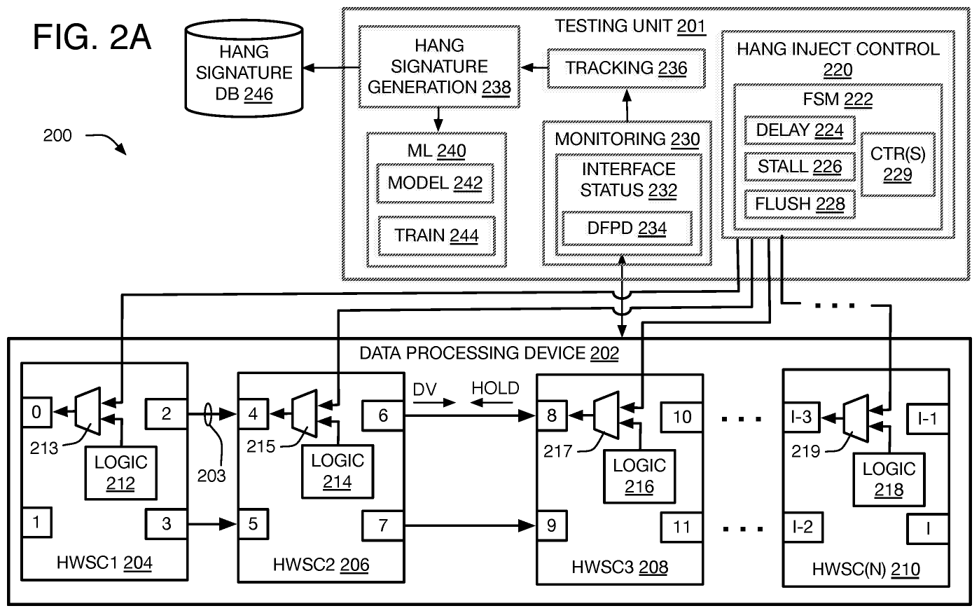

Each arrow between subcomponents represents an edge (or circuitry for a single pathway or interconnection) with a pair of interfaces (shown better on FIG. 2A), with one interface at each subcomponent and including a sender (or source) interface on a sender or source subcomponent and target (or receiver) interface on a target or receiver subcomponent that controls the data transfer between the two subcomponents. Each edge may represent a post-silicon data bus or other type of transmission line (or lines) and may be in the form of, post-silicon, integrated circuit (IC) semiconductor device metallization such as vias, traces, and so forth and is not particularly limited as long as the interfaces can transfer data between subcomponents and can have control and monitoring signals as discussed herein.

The interfaces herein may be monitored to detect whether a pair of interfaces at an edge (or arrow) has an activity status such as (1) idle where the sender has nothing to send and the receiver is not ready to receive, (2) active where either (a) both the sender has data to send and the receiver is ready to receive data, or (b) data is currently being transferred between the sender and receiver interfaces, (3) stall where the sender interface is ready to send while the receiver interface is not ready to receive (also referred to herein as backpressure), or (4) starve where the sender interface does not have data to send while the receiver interface is ready to receive. It will be noted that while the status term starve generally can refer to when the sender has no data to send regardless of the status of the receiver, herein it only refers to the situation when the receiver is ready to receive data (or in other words, a starve strict status).

In the present example of device 100, an intentional artificial stall is injected between subcomponents 130 and 140. The testing system waits for the cascade of the activity status to the other subcomponents in the hardware pipeline of the device 100 by applying the stall until a steady state is reached. The activity statuses, here shown as mostly stall or starve with a few at idle, are then collected to generate a reference hang signature. This can be repeated to inject the unintentional stall at different interfaces, and with variation of other parameters, to form multiple reference hang signatures each representing a different hang scenario, that can be collected into a reference hang signature database.

Referring to FIG. 2A for more detail, a data processing system 200 has a simulated data processing device (or pipeline) 202 representing a real, physical hardware device, and communicatively coupled to, or may be part of, a testing unit 201, also referred to herein as, or may include, a test bench. The testing unit 201 can be used to inject a stall and construct a reference hang signature database. The data processing device 202 may be provided to perform any computer-related function, such as video coding, and may have multiple hardware subcomponents 1 to N (HWSCI to HWSC(N)) numbered evenly 204 to 210, wherein four subcomponents are shown in a linear arrangement although the arrangement may include any desired number of subcomponents in any arrangement, including non-linear arrangements, as long as interfaces here numbered i=0 to I transmit data between at least two of the subcomponents n=1 to N (204 to 210). The interfaces also may be referred to as subcomponent interfaces (SIFs) so that each edge has a pair of SIFs. The subcomponents 204 to 210, and any or all of the circuitry and logic shown thereon, may be pre-silicon representations of corresponding hardware subcomponents with actual physical processing circuitry of an actual physical data processing device. Thus, here the subcomponents have simulated interfaces 0 to I, as well as logic numbered evenly and respectively from 212 to 218 for the four subcomponents 204 to 210. This respectively may include multiplexers 213, 215, 217, and 219 used for injecting hangs as described below. Thus, the actual, real, or physical circuitry that runs the software representing the subcomponents 204 to 210 may include many different integrated circuit or other processing circuitry structures, including CPUs, GPUs, ISPs, SoCs, FPGAs when emulation is being performed, and so forth.

This hardware may be running RTL or other simulation or emulation code to simulate or emulate real subcomponents corresponding to simulated subcomponents 204 to 210 and interfaces 0 to I. Thus, it should be noted that while the simulated subcomponents 204 to 210 are shown with simulated representative circuitry from the logic units 212 to 218 to the multiplexers 213 to 219 to control the interfaces, and hang inject circuitry is shown from the testing unit (or testbench) to the multiplexers 213 to 219, in reality, the control signals and inject hang signals “flow through”, or in other words is established by, algorithms within the testbench 201 itself. The real physical hardware may have the control signal circuitry as well as activity status message monitoring circuitry and logic, but does not need to have real hang injection circuitry as described below.

The testing unit 201 may have a hang inject control (or stall control) unit 220 that may have a finite state machine (FSM) 222 with a delay unit 224, a stall unit 226, a flush unit 228, and one or more counters 229. The counters 229 may include at least one of a random delay (RD) counter, a stall start (SS) counter, a stall propagate (SP) counter, and/or a recovery (REC) counter. As disclosed below, any or all of these counters may be combined into a single counter, and may be associated with one or more clocks (CLK) not shown. The hang inject control unit 220 is arranged to inject a hang at a selected or random interface 0 to I, and by one form at a single interface for each reference hang signature to be generated.

The testing unit 201 also may have a monitoring unit 230 with an interface status unit 232 that in turn may have a Design For Performance Debug (DFPD) unit 234 that may be DFPD registers that indicate or generate interface activity status codes from the interfaces 0 to I. By one example, each pair of interfaces at an edge interconnecting two subcomponents each may provide a control signal bit that can be combined to form a two bit interface activity status code for each connected pair of interfaces at an edge. For example, interfaces 2 and 4 connecting subcomponents 204 and 206 via an edge, line, or arrow 203 may have a two bit code indicating the status of the two interfaces 2 and 4, including those mentioned above: starve, stall, idle, or active.

A tracking unit 236 receives the activity status codes from the monitoring unit 230 and provides the activity status codes to a hang signature generation unit 238, which provides hang signatures to a machine learning (ML) unit 240 that has an ML model 242 and a training unit 244 to train the model 242. The hang signatures generated by the hang signature generation unit 238 also are placed in a hang signature database (DB) 246.

In more detail, the logic units 212, 214, 216, 218 of the subcomponents 204 to 210 have simulated logic, circuitry, programming (or code), and so forth in order for the subcomponent to perform a certain function or operation. For video coding as one possible example, say logic 212 on subcomponent 204 may perform image data partitioning, logic 214 on subcomponent 206 may perform residual computation, logic 216 on subcomponent 208 may perform transform of the image data, and so forth for encoding. The logic units 212, 214, 216, and 218 also may control the interfaces on the same subcomponent. Thus for example, logic 212 may control the interfaces 0 to 3, and logic 214 may control the interfaces 4 to 7, and so forth. The logic or logic units 212 to 218 may transmit control signals to the interfaces. Each control signal from one of the logic units 212 to 218 may be provided to one of the multiplexers (whether a different multiplexer or a shared multiplexer) 213 to 219 numbered with odd numbers. Thus, while only one of the multiplexers 213 to 219 is shown on a subcomponent, either each interface 0 to I may have its own multiplexer or two or more, or all, of the interfaces on a single subcomponent share the same multiplexer. Each multiplexer 213 to 219 also may be coupled to the hang inject control unit 220 through a hang inject signal line.

Using interface 4 as an example, and when the hang inject control unit 220 is to inject a hang at interface 4, the hang inject control unit 220 will generate the hang inject signal by using the FSM 222 to control the timing of a signal to stall the data transfer at interfaces 2 and 4, and by sending the hang inject signal to the multiplexer 215 to modify the control signal from the logic 214 to indicate a stall at the interface 4. The duration of the stall is controlled by the hang inject control unit 220, and particularly by the FSM 222. Generally, the stall is held until the activity status can be obtained for of all of the interfaces (or those being monitored when a hang occurs) after the subcomponents reach a steady state.

Each pair of interfaces at an edge generally can be referred to as a single interface when discussing the type of interface that is used by the logic 212 to 218 to control the interfaces. For example, one type of interface is a data validated (DV) and hold (or DV-hold) interface. In this case, the interface control signals used by the logic may include a DV control signal to indicate the validity of the data at a sender interface that is ready to be sent, and a hold signal that indicates the readiness of a target or receiver interface to receive the data. A transfer signal also may be provided to activate actual data transfer from the sender to receiver (or target) interface. As mentioned the DFPD unit 234 receives the control signals, and then wither the DFPD unit 234 or the interface status unit 232 directly translates the DV-Hold interface into four unique combinations of the DV and the HOLD signals to establish the four DFPD states: starve, stall, idle, and active as described herein. Another type of interface is a Credit-Release based protocol interface where the interface status unit 232 may achieve the DFPD classification by performing an intermediate conversion of put and credit release signals into their DV-Hold interpretation. This can be performed for many other different types of interfaces such request/acknowledge protocol, and so forth.

The tracking unit 236 next arranges and formats the DFPD codes for output to the hang signature generation unit 238 as well as for output or viewing by users or analysis by other units of the testing unit 201. The tracking unit 236 also provides a code for the identification of the interface that has the injected hang, here interface 4, and which may be a binary code as desired. Otherwise, the tracking unit may handle the activity status signals in a certain order that indicates the location of the interface being handled and that had he hang.

By one form, the hang signature generation unit 238 may concatenate the activity status codes for all the interfaces, or place them in a certain code order, such as comma-separated values (CSVs) if not already performed by the tracking unit 236, and then look up a corresponding field in a hang signature database 246 reserved for interface 4, for example, to hold the hang signature with a hang at interface 4. The hang signatures in the database may be referred to as reference hang signatures and the database as a reference hang signature database (DB) 246 where interface is IF 0 to I. Thus, in this example, the reference hang signature only has activity status codes, and does not have a code for the location or identification of the interface with the hang as shown on DB Table below. The status stall, starve, and idle would have the code values (herein binary) itself that form the hang signatures. Alternatively, however, the reference hang signature could have a code for the interface location with the injected hang.

DB Table

| | Activity | Activity | Activity | | Activity | Activity |
|---|---|---|---|---|---|---|
| Hanged | Status | Status | Status | | Status | Status |
| Interface | IF 0 | IF 1 | IF 2 | . . . | IF I - 1 | IF I |
| 4 | Stall | Starve | Stall | . . . | Starve | Idle |
| 5 | Stall | Stall | Stall | . . . | Idle | Idle |
| I-2 | Stall | Stall | Starve | . . . | Stall | Idle |

Also, the machine learning unit 240 may use the reference hang signatures from the hang signature generation unit 238 to train a machine learning model 242, such as with a decision tree type of algorithm. The machine learning (ML) model may be trained to identify an interface with a hang, when one exists, by comparing a hang signature being tested (or during a run-time also referred to herein as the generated or hidden hang signature) to the reference hang signatures in the database 246. The ML model may be trained to identify the interface with the hang even when no exact match exists between the hidden hang signature and the reference hang signatures. In these cases, the ML may be able to identify the interface with a hang when at least one or more of the values of the hidden hang signature is different than the reference hang signatures.

Herein, a hidden hang or hidden hang signature is defined as relating to the existence and/or the determining of the location of the hang at a particular subcomponent when the location of the hang is unknown to a classifying model or algorithm, which may be a ML model described herein or other type of model, that is to determine the location (the subcomponent and/or interface) that caused the hidden hang. Thus, a hang is considered hidden even though the hang's existence is already detected by other units, such as by assuming the hang's existence when a hang stops data flow in the device, or when an intentional testing hang is injected to a subcomponent and provided to the classifying model to test the classifying model.

The injection of the hangs and the generating of the reference hang signatures may be repeated by introducing the stall at different interfaces for the same hardware network device 202. Interface-activity signals are captured for each of the steady state hang cases. With this process, a large dataset is generated for the system and held in the database 246. This dataset then is ready to be used for hang classification purposes.

Referring to FIG. 2B, a data processing system 270 may be provided to detect and classify a hang in the transmission of data at the processing device 202, or here electronic data processing device 272, which may be the same or similar simulated device as device 202, or may be a real physical device represented by device 202. When the device 202 is a real device 202, the device 202 still may be used for testing or may be used for hang detection during a run-time.

The data processing system 270 may have a test application 274, such as video coding, that is being run on the device 272. An initial hang detection unit 276 may be monitoring the device 272 while the application 274 is running to make an initial determination as to the existence of a hang. By one form, this determination can be based on a pipeline activity counter. If the counter (or signal) is too high, then it is assumed a hang exists. Once an initial determination finds a hang exists, a hardware driver 277 obtains activity status of the interfaces from an interface status unit 232 that has registers or DFPD unit 234 to receive interface activity codes as described above and may be the same or similar to status unit 232 or may be a different real hardware register bank or array. The HW driver 277 provides the status codes to a hang locator unit 278, and specifically to a detected hang signature generation unit 280 to generate new, generated, or hidden hang signature, where hidden refers to the location of the hang initially being hidden from the machine learning model 242. The hidden hang signature is provided to a hang signature look-up unit 282, which then retrieves the reference hang signatures from the database 246. Both the hidden hang signature and reference hang signatures are then provided to the machine learning (ML) model 242. The model 242 computes the identification of the subcomponent interface 0 to I with the hang.

The identification of the hang may be output to the users and/or may be used by a recovery unit 286. As described below, with the identification of the interface with the hang, local recovery may be performed only on the subcomponent causing the hang without the need to apply recover routines to other subcomponents, thereby potentially saving large amounts of time, power, and so forth. It also improves user experience where instead of resetting the whole system to recover a hang, a certain localized hardware is reset.

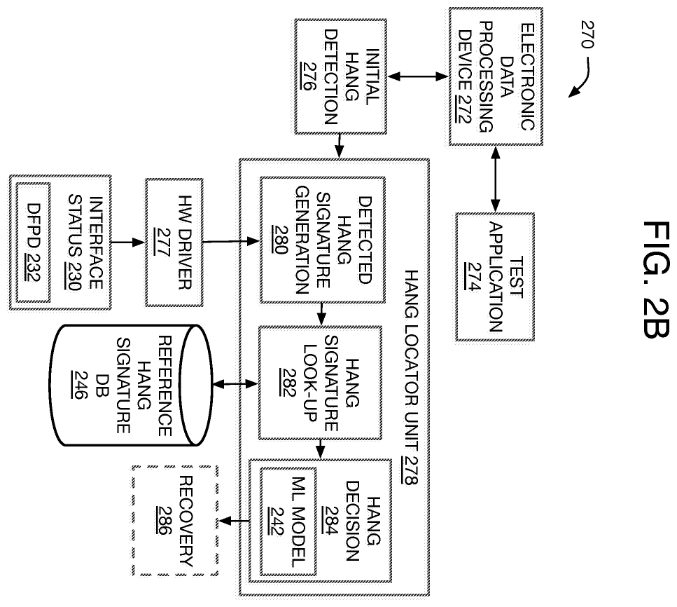

Referring to FIG. 3, an example process 300 of efficient and accurate data processing pipeline hang classification, and particularly to generate a database of reference hang signatures, is arranged in accordance with at least some implementations of the present disclosure. In the illustrated implementation, process 300 may include one or more operations, functions or actions as illustrated by one or more of operations 302 to 318 numbered evenly. By way of non-limiting example, process 300 may be described herein with reference to example systems, devices, models, or machines 100, 200, 400, 500, 1000, 1100, and/or 1200 of FIGS. 1, 2, 4, 5, and 10-12 respectively and as discussed herein.

Process 300 may include “run application/network workload” 302. This operation may include running an application such as for video coding or any other desirable data processing application so that an intentional hang can be injected while the video coding application is processing data. The type of application is not limited as long as it can be represented as hardware subcomponents and interfaces as described herein. The application may be run on pre-silicon testing software representing subcomponents interconnected by the interfaces described in FIGS. 1 and 2A-2B. The software may be, or include, register-transfer level (RTL) code with general purpose (or specific testing function) hardware, or emulation hardware with gates (FPGAs for example), flip-flops, and so forth with specific assignments and functions to certain subcomponents and interface operations to run the application. Other than RTL, the debug or testing software may be coded by using other known testing software. As described herein, the interfaces may be DV-hold interfaces or credit-release interfaces, although other interfaces such as request-acknowledge interfaces may be used instead. Note that while process 300 may be needed only during a pre-silicon phase, the generated reference hang signature database 246 will be used for both pre-silicon and post-silicon.

Process 300 may include “inject a hang of data transfer on at least one of a plurality of interfaces interconnecting simulated or emulated hardware subcomponents arranged to send or receive data transmitted between the subcomponents” 304. Preliminarily, the disclosed method and system achieves its hang detection and classification capability by developing a mechanism that enables controlled and targeted hang injection at the interface level and monitoring the pipe-level interface activity signals at steady state after the hang. The injection of the hangs at specific targeted interfaces may be accomplished by using hang classification infrastructure including the signal transmission circuitry that controls the interfaces and monitors the status of the interfaces.

Regarding one example form of the interface control signals and interface status monitoring, dedicated interface activity monitoring hardware is implemented throughout the hardware pipeline when there is data exchange between any given two hardware subcomponents. Design For Performance Debug (DFPD) signals may be used with interfaces to report activity status at the interfaces. DFPD signals are used to facilitate the pre-silicon and post-silicon analysis and debug of micro architectural performance. Part or all of the DFPD interface status signals may be exposed (accessible) on post-silicon physical VISA PORTS or other DFX (Design for Excellence) testing arrangements. Because a VISA is a limited resource, and in some hardware the DFPD signals are only available through the VISAs, in this case, the entire interface may not be exposed and detectable through ports in the final silicon product between any two given interfaces, and other types of monitor signals may be used for pre-silicon testing. For post-silicon testing, however, these hang activity signals still can be read in the hardware readable registers so that software can read the status. Since DFPD signals are used on post-silicon debugging in the present example, the pre-silicon testing systems also use or simulate the DPFD signals as well in order to achieve a more accurate simulation of the post-silicon operation.

Thus, the DFPD signals are helpful in characterizing the status of data transfer through a pipeline, and hence in debugging during pre-silicon testing. As mentioned, interface activity between any two subcomponents can be described as either active, starve (or starve strict), stall, or idle and depending on the validity of the data from the source and the readiness of the target to receive that data.

Specifically, for DV-Hold interfaces at a single edge or pathway (or interconnection), a sender interface and a receiver (or target interface) are provided as mentioned above. By one form, each of the two interfaces at the edge may have a binary code so that the two interfaces cooperatively form a two bit code to provide four unique combinations of the DV and the HOLD signals as follows.

TABLE 1
Interface-Activity Signal Definition

| | | Interface- | |
|---|---|---|---|
| | | Activity | |
| DV | HOLD | Status | Description |
| 0 | 0 | Starve | Sender module has nothing to send, target |
| | | (Strict) | module is ready to receive data. |
| 0 | 1 | Idle | Sender module has nothing to send, target |
| | | | module is not ready to receive data. |
| 1 | 0 | Active | Data transfer is occurring |
| 1 | 1 | Stall | Sender module is ready to send data, but |
| | | | target module is not ready to receive |
| | | | (backpressure). |

As described in greater detail below, the DV and Hold control codes may be binary on/off signals and these can be manipulated to inject a stall, which can result in an intentional hang. For monitoring purposes described below, the DFPD unit 234 may have registers to collect the control code of each interface and then the interface status unit 232 may combine the control codes of the pair of interfaces at each edge to generate the activity status codes as on table 1. For Credit-Release based interfaces, or other types of interfaces, the DFPD classification may be achieved through an intermediate conversion of credit and release signals into DV-Hold interpretations, and this may be performed by the interface status unit 232 as well.

An artificial stall is injected at a single edge at a time and in the pipeline in a controlled way. By one form, these stalls may be operated by a hang (or stall) inject control unit 220 in the test unit or bench 201. The injection creates back pressure between any two given interfaces of the same edge, which then results in a cascading effect to stall or starve many of the other interfaces, and in turn edges, in the hardware pipeline.

As to more detail for the hang injection process at operation 304, first, an interface is selected for injection of the hang in the examples herein. The selection may be random and may proceed with random selections thereafter for each reference hang signature to be generated, or may have some order such as in operational or temporal order in the application being run, or some other desired order such as giving priority to the interfaces which are more vulnerable for a hang due to memory corruption, bad programming, or programming error injected through a rough driver or by a hacker. Thus, the FSM 222 is applied to one interface pair (one edge) at a time, but other number or orders of interface injection could be used instead. For example, multiple interfaces may be intentionally stalled in parallel to generate even more reference hang signatures if desired. The present example stalls one interface edge at a time.

Another varied parameter is the workload. Thus, for video coding as one example, a very low computational load may be achieved by controlling encoder or decoder parameters such as by controlling partition options, prediction options, quantization and bitrate options, loop filter settings, and so forth. Additionally, or alternatively, the image data, or in other words the seeds, may be modified to provide a low computational load by compressing flat, plain images with a single color on an image for example, while a heavy load may have very complex images with many moving objects in the images. Other non-graphic applications may have the workload and seed varied in other ways.

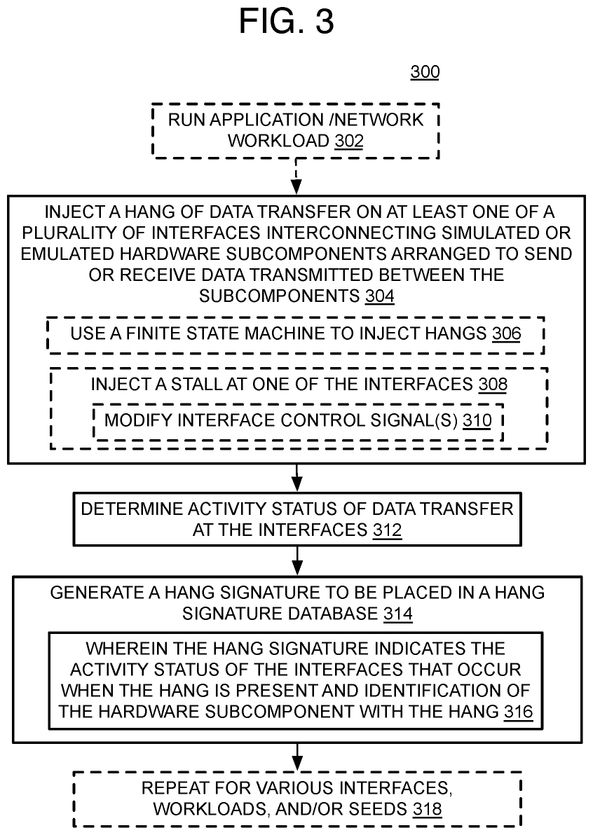

Referring to FIG. 4, and for more detail to use the activity status codes to inject a hang, operation 304 may include “use a finite state machine (FSM) to inject hangs” 306, and “inject a stall at one of the interfaces” 308, and including at least one of the interfaces. Specifically, a pipe-level stall or hang injection RTL infrastructure in the form of a finite state machine (FSM) or algorithm 400 is shown with stages or states 402 to 410 numbered evenly.

In an idle stage 402, no interface is hanged. If there are still interfaces yet to be hung, an interface is identified and the status of the DFPD signal of that interface is observed.

By one form, a stall may be injected when the selected interface is actively transferring data because a hang is especially meaningful if it inhibits active data transfer. In other words, a hang during an idle status or no data transfer is not associated with a scenario that provides significant data that indicates real hang behavior of the system. Therefore, data transfer should be ongoing (DFPD status equals active) when the hang is to be injected. Thus, the edge to be injected with the hang will initially have an activity status code of 10 for active status where the sender interface has a DV code of 1 and the receiver (or target) interface has a hold code of 0 according to Table 1 above. Thus, an initial wait is performed at the idle state or stage until the interface to be injected with the stall is active.

In a random delay stage 404, once the interface to be intentionally hung has a DFPD status that is active, the FSM may prepare to hang that interface. This first may include waiting a randomized delay, and this may be performed after receiving an active status signal of any interface to be hung. The random delay inserts a further variation in the collected data and may be used as a varying parameter to increase the number of different hang signatures, and in turn, to increase the size of a dataset to be used for machine learning. The random delay may be set by using a random delay (RD) counter that is associated with a clock (CLK) not shown, and the RD counter should be set shorter than a maximum random delay that is a time to process a whole workload, while and longer than a minimum delay that is zero. This is to better ensure, for different workloads, that for the same interface, hang signatures are generated at different points while executing a workload (i.e., video).

In a wait for stall state 406, and once the random delay elapses, the FSM may re-check the interface to be injected with the hang to make sure the interface, or more precisely edge of two interfaces, is still active. A stall start (SS) counter starts incrementing at this state. The hang inject control unit 220 waits for the active status of the interface to be maintained until the stall counter hits a maximum value. The maximum value of the SS counter may be set by the testbench and it may be programmable by the testbench so that it can vary depending on the workload size for a specific test, as one example. If the interface no longer has an active status at the wait for stall state, the FSM returns to the idle state and prepares to hang the next interface.

If the interface is still active, in an inject stall state 408, the hang is injected to a particular interface and operation 304 includes “modify interface control signals” 310. The stall is achieve by forcing the hold, DV, or credit-release signals to be either high or low as described below, thereby subsequently changing the status of the edge being injected with the hang from active code 10 to stall code 11 from Table 1 above. This is described in greater detail below.

Continuing with the FSM states, either the stall start (SS) counter is restarted or a second stall propagate (SP) counter starts incrementing at the initiation of the inject state 408, and the forcing of the injection is maintained until the stall propagate (SP) counter hits its maximum allowed value, and ideally the pipeline has reached a hung steady state by then. Thus, the maximum count, and in turn stall propagate delay, by the SP counter is set to allow a sufficient amount of time for the hang or the backpressure to propagate through the pipeline until a steady state is reached, and before the DFPD signals are collected. The result is that most interfaces on the pipeline will be in a stall or starve state, though some can be in an idle state, but none of the interfaces are in an active state, as shown on system or pipeline 100 (FIG. 1). The SP counter maximum value may be set to a steady state which simulates a real-life silicon hang.

After the SP counter has elapsed and the steady state is assumed, or a steady state is detected by other methods such as by using an interface toggle monitoring module in the testbench, the collected monitored activity statuses at a DFPD unit or interface status unit may be provided to the tracker unit to label and record the activity status of the interfaces as well as the identification of the interface that was injected with the hang.

In a flush pipeline state 410 of the FSM 400, by one form, and before moving on to the next interface to hang, the pipeline may be permitted to recover from the current hang by flushing the pipeline. For this recovery, the FSM 400 stops injecting the hang and the pipeline re-continues to process whatever the pipeline was processing before being interrupted by the hang. This may include completing processing of a tile for video coding as one possible example. The FSM 400 then returns to the idle state 402 to hang any next remaining interface edges not hung yet. By one alternative, the recovery time may be tracked by a recovery (REC) counter and may be used as a seed to generate the random delay for the subsequent interface to hang given its random nature.

It will be appreciated that to cover a wider range of possible bugs, different iterations of the FSM can be used by the hang control unit 220 and FSM 222 or 400. For example, the FSM 400 may be operated without including a wait for stall state so that the hang may be injected even though the interface being hung is in an active state. In other alternatives, a fixed delay may be used such as two cycles instead of a random delay.

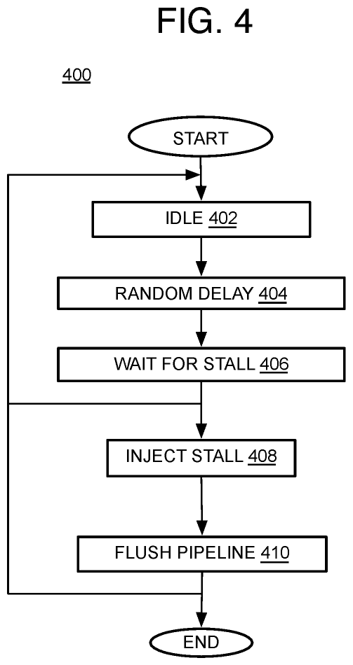

Referring to FIG. 5 for an alternative FSM 500 to better debug corner cases, the FSM 500 is similar to FSM 400 with here states or stages 502 to 510 numbered evenly, except here FSM 500 has an additional alternative flow order (shown in dashed arrow) for enhanced backpressure injection capability. In this case, the FSM 500 stalls the same interface pair or edge multiple times in a row with a random delay (which may be a different duration each time) between each stall injection. This enables targeting and modulating stress at a specific interface so that different time dependent stress conditions are validated and corner case functional RTL bugs can be exposed.

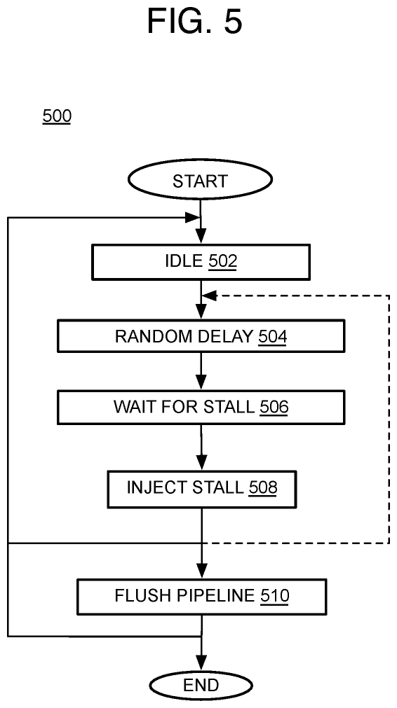

Referring now to FIGS. 6-8, an example of the alteration or modification of the control signals by the inject stall state 408 is shown. For comparison, a temporal interface control signal graph 600 (FIG. 6) shows normal operation (without a hang). At an edge described above, a source interface, such as interface 2 (FIG. 2A) for example, brings a DV signal high (or on) with a binary code of 1 when it is ready to transfer data, and the target interface 4 indicates its readiness to receive data with a low (or off) hold signal with a binary value of 0 as shown on graph 600. In this situation, data transfer can occur and the activity status code (10) is active. The transfer signal indicates transfer of data (active status) between the two interfaces 2 and 4, idle occurs when the DV signal is low (0 or off) and the hold signal is high (1 or on) with activity status code (01). When the DV signal switches to high (1 or on) while the hold signal is still high (1 or on), this is a stall status with activity status code (11). When the DV signal switches to low (0 or off) while the hold signal also is low (0 or off), this is a starve status with activity status code (00) as shown. It will be appreciated that the binary codes here are merely one example and other codes could be used instead. The activity status is shown at the DFPD line on graph 600, and the periods of a clock signal CLK also is shown on graph 600.

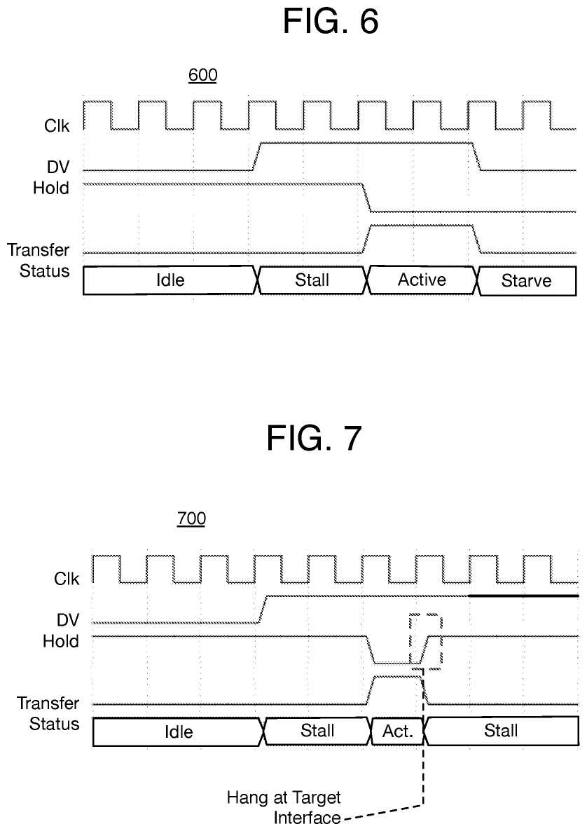

Referring to FIG. 7, a graph 700, similar to graph 600, shows interface control signals when hanging the receiver (or target) interface (say interface 4 to continue the example from graph 600 and above). Thus, when hanging the target interface, the hang control unit 220, or particularly FSM 222, waits for data transfer to be maintained (DFPD active) for a random delay RD count and stall start (SS) count, and then provides a stall signal to the multiplexer 215 which forces the hold of the target interface 4 to go high as shown and by altering the hold control signal from logic 214 at the multiplexer 215, for one example. This introduces an artificial backpressure that inhibits the data transfer. The multiplexer 215 performs the injecting or forcing by adding a target stall signal 1 to the hold signal 0 while the interface status is active (10). It will be appreciated that other logic devices could be used in addition to, or instead of, the multiplexer. For simplicity, the graph 700 assumes a random delay of 1 clock cycle, and the signals are controlled directly by the hang inject unit 220.

After the hang is injected at the target interface 4, the DV signal from 2 will remain the same because HOLD from interface 4 is made high. As a result, no new data will be sent from interface 2, and resulting in a stall state in the interface 4.

Also, the hang inject unit 220 may use a separate hang signal or code that indicates a hang by adding two 1-bit signals (a stall signal hang_ip_src and a hang_ip_target) which indicates whether a hang is in progress. This hang indicator signal is provided to indicate a hang on a testbench and while injecting the stall for the hang. These two hang indicator signals may be added to a library interface module of a testbench so that the hang injection is easily scalable.

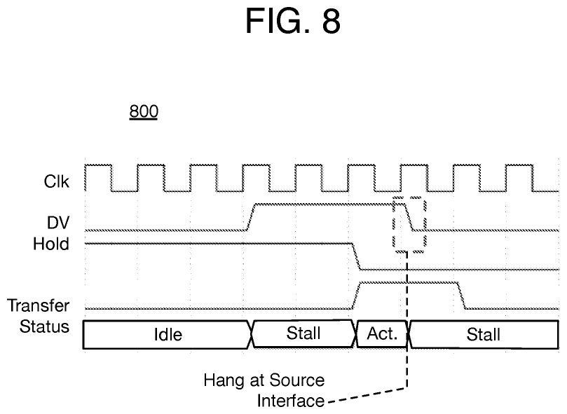

Referring to FIG. 8, a graph 800 shows interface control signals when hanging the source interface. Here, the FSM 222 and hang inject unit 220 use a similar procedure to that explained for the injected hang at the target interface. When hanging the source interface, such as interface 2 (FIG. 2A), the DV signal is now forced to go low to inject a starve status at the interface 2 to inhibit a data transfer.

Returning to process 300, process 300 may include “determine activity status of data transfer at the interfaces” 312, and as mentioned after a SP count to a steady state or at least until a steady state is otherwise detected. Thus, to monitor the activity status of each interface, interface-activity signals are captured (by DFPD unit for example) for each of the steady state hang cases. The DFPD unit may have a register for each control code received and then combines the control codes of each pair of source and target interfaces at each edge to form an interface activity status code. In the pre-silicon testing, these statuses can be captured through the tracker unit, and also reported in hardware registers which are readable by the software. Note that data collection includes the DFPD signals of all interfaces of interest throughout the pipeline at the hang steady state (which may be indicated whenever the FSM transitions to the FLUSH_PIPELINE state).

Process 300 next may include “generate a hang signature to be placed in a hang signature database” 314, which may be referred to herein as reference hang signatures in a reference hang signature database (DB) and that may be generated for each or individual hang that is injected. Particularly, operation 314 may include “wherein the hang signature indicates the activity status of the interfaces that occur when the hang is present and identification of the hardware subcomponent with the hang” 316. Thus by one approach, all of the activity status codes are concatenated together, or otherwise formatted such with CSV, to form a reference hang signature. This may be in any desired order, such as temporal or procedural according to the application being run, as long as the same order of interface codes is maintained in the hang signatures for both generation of the reference hang signature database and for new hidden test or real hang signatures that are to be fed to a machine learning or other algortithm or model to determine if a hang exists and to classify the location of the hang among the interfaces.

By one form, the reference hang signatures are placed in memory or in a database field or order that indicates which interface has the injected hang so that a code for the location of the injected hang does not need to be in the hang signature itself and does not need to accompany the hang signature. By other alternatives, a code for the location or identification of the interface with the hang is placed within the hang signature itself or accompanies or is otherwise associated with the hang signature. This may be a binary value with a range depending on the number of interfaces being monitored.

Process 300 may include “repeat for various interfaces, workloads, and/or seeds” 318. As mentioned, to increase sample size to provide as many reference hang signatures as possible for training of a machine learning or other algorithm, such as neural network, classification model to classify a hang, this process is repeated by introducing stall at different interface points for the same hardware network as well as by altering the workload and input seeds. With this process, the result is a large dataset then may be used for training the ML model for the system.

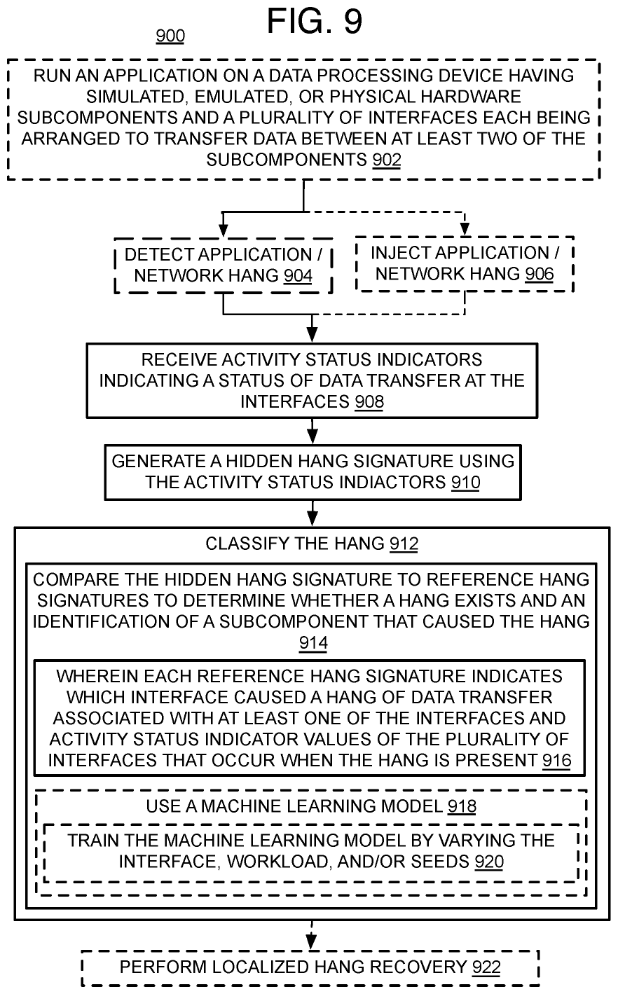

Referring now to FIG. 9, an example process 900 of efficient and accurate data processing pipeline hang classification, and particularly to identify hang locations on hardware subcomponents and/or interfaces, is arranged in accordance with at least some implementations of the present disclosure. In the illustrated implementation, process 900 may include one or more operations, functions or actions as illustrated by one or more of operations 902 to 922 numbered evenly. By way of non-limiting example, process 900 may be described herein with reference to example systems, devices, model, or machines 100, 200, 400, 500, 1000, 1100, and/or 1200 of FIGS. 1, 2, 4, 5, and 10-12 respectively and as discussed herein.

Process 900 may include “run an application on a data processing device having simulated, emulated, or physical hardware subcomponents and a plurality of interfaces each being arranged to transfer data between at least two of the subcomponents” 902. The applications are described with process 300, and here this process of hang classification may be performed pre-silicon or post-silicon. The hardware and software (or firmware) being used is as described above with FIGS. 2A-2B.

Process 900 may include “detect application and/or network hang” 904. This involves/an initial detection of a hang in order to turn the disclosed hang classification system on. Thus, a tool (initial hang detection unit 276 (FIG. 2B) can be used in parallel to the disclosed hang locator unit 278 (FIG. 2B) in the testbench or other location that will be used to subsequently classify the hang. For the initial detection of the existence of a hang, a hang detector may detect a hang in the pipeline based at least partly on a pipe activity counter. If a hang detector signal or count goes sufficiently high, indicating an initial hang detection, then the hang locator can proceed with hang classification.

By an alternative, process 900 may include “inject application network hang” 906, where a hang is being injected in order to test the accuracy of the ML model 242. In this case, the initial hang detection may be omitted, and the location of the hang within the pipeline is known to the test unit, although not “known” (and therefore hidden) to the hang decision unit 284 and ML model 242 itself. In other words, data directly indicating the knowledge of the hang location is not input to the ML model.

When any real or hidden hang is initially detected in the hardware (or is intentionally injected into an interface), all or individual interface-activity signals are captured. In this case, process 900 may include “receive activity status indicators indicating a status of data transfer at the interfaces” 908. Here, the DFPD signals can get passed to the monitoring unit and tracker unit at the moment of the hang for pre-silicon testing. For Post-Silicon hardware debugging, message channels in the integrated circuits or chips may be used, and the DFPD signals of all interfaces being monitored across the pipeline can be collected by a status unit and then read from the status registers at steady state by an HW driver.

Process 900 may include “generate a hidden hang signature using the activity status indicators” 910. For pre-silicon, this is performed by the tracker or detected hang signature generation unit 280 using the collected data directly as described above. For post-silicon, those signals read by the driver can be expressed in a comma-separated values (CSV) format line in the appropriate order (see example ML script below) and that can be used by the ML model trained during pre-silicon testing to encode those CSV signals into hidden hang signatures and infer the location of the hanged interface. In either way, the format of the hidden hang signature should be that expected by the ML model, and may include a list or concatenation of the collected interface activity status codes at a time of the hang being classified. In this case, the code for the location of the hidden hang cannot or will not be provided with the hidden hang signature.

Process 900 may include “classify the hang” 912. Operation 912 may include “compare the hidden hang signature to reference hang signatures to determine whether a hang exists and an identification of a subcomponent that caused the hang” 914. This uses a model or algorithm, such as an ML model to debug and determine a root-cause of many different simulation hangs during pre-silicon validation, and then during post-silicon validation as well. This automated method will save significant debug time. The ML model may be one of a machine learning decision tree, K-nearest neighbors (KNN) classifier, or random forests algorithm, or other model, such as a neural network-based model. The machine learning model determines a most-likely subcomponent of the hang even when the hidden hang signature is different in one or more values to all of the reference hang signatures.

Operation 914 may include explain “wherein each reference hang signature indicates which interface caused a hang of data transfer associated with at least one of the interfaces and activity status indicator values of the plurality of interfaces that occur when the hang is present” 916. Thus, the reference hang signatures are the hang signatures generated during pre-silicon testing and placed in the hang signature database (DB) 246 as described above. The database is used to train the machine learning model. By one form then, operation 912 may include “use a machine learning model” 918, and this may include “train the machine learning model by varying the interface, workload, and/or seeds” 920. Specifically, the data collected in the form of reference hang signatures and the knowledge of the hang interface location for each reference hang signature may be used to train and test the machine learning model. The data collected may be a labeled data set, where the datapoints are vectors of interface-activity signals, such as DFPD signals, tracked throughout the pipeline, as well as the labels which is the identification of the interface that was intentionally injected with a hang to generate that datapoint for each reference hang signature. The ML model is trained to predict the identification of the interface causing a hang in the pipeline based on the interface-activity signals across the pipe.

The classifying 912 and particularly the comparing performed by the ML model in operation 914 may include looking up the reference hang signatures in the database and providing the hidden hang signature and the reference hang signature to a hang decision unit that operates the ML or other model as mentioned above. The model outputs the identification of the interface, and/or subcomponent, with the hang associated with the input hidden hang signature.

Process 900 may include “perform localized hang recovery” 922. This hang detection method can be used to classify many different hangs and clear the hang locally. A hardware pipeline, i.e., video encoder or decoder, can hang due to network noise for example. By using the disclosed method, the hang in the entire pipeline can be localized, and therefore, the hang can be cleared by using localized hang recovery flow rather than performing recovery on all or even many subcomponents in the pipeline. For post-silicon, when hardware is unresponsive to an unrecoverable error, a driver reads the interface-activity signals through status registers at first, and then it can classify the hang based on the training dataset as described herein. The driver then can trigger software-controlled localized hang recovery flow for that specific part in the pipeline.

For one alternative form, and in existing image or graphics processing models, a hang counter exists that detects any hang in the system and generates interrupts using a graphics microcontroller (GUC). A driver understands that there is a hang, and can read the DFPD signals through the message channels. From there, the driver can infer the hanged interface or subcomponent using the disclosed ML model, either through software or a hardware solution. The driver can then flag the hanged interface which can be used for debugging. For additional enhancements, the result can be used to reset the specific power domain causing the hang. This solution can be scaled to the entire graphics processing pipeline where the same generic standard interfaces are being used across all units or subcomponents.

### Proof of Concept (POC)

A few machine learning classification models were tested as a proof of concept, where hangs were injected in a video encoder hardware pipeline at different interfaces and interface-activity signals were monitored. Hangs were injected into interfaces across multiple subcomponents from an encoder pipeline, for a total of 14 interfaces hanged. The subcomponents chosen were major modules for encoding: Fourier Transform, Quantization, Entropy Encoding, Arithmetic Encoding, Prediction, Inverse Transformation and Quantization modules. However, the test monitored the hang across 11 different subcomponents, for a total of 18 interface pairs monitored.

Each interface (going forward referred to as a subcomponent interface (SIF) of interest in the pipeline was given a name and a label. Subcomponents (here called units) were labeled as well. A Python® automation script (automate_code.py) was then used to populate the main parts of the monitor and stall control modules. This automated script was developed to ease the expansion and scalability of this tool to different pipelines. Below is an example of part of the Python® automation script. This script is used by the DFPD tool for code automation. The following example psuedo code script generates System Verilog code for a hang_ctrl.sv file, where src is a source interface and target is a target interface.

Given a CSV file with the format:

```
  SIF name, src=1/target=0, SIF label, unit, Corresponding unit label, Path of SIF
    *Assumption: SIF name is of the form:[SRC_UNIT][_[TARGET_UNIT]_[DATA]
It generates 3 code segments:
* Path definition: defines the paths of the hang_ip_src and hang_ip_target signals with
      readable MACROS to be used when forcing those signals.
* Struct generation: used when defining the sif_status structs which include the sif name, unit,
      and whether it is a src or target. The sif status structs are also used
      to assign the hang_ip_src target signals later in the code.
* Signal forcing: used to force the hang_ip_src and hang_ip_targhet signals based on their
      paths to their corresponding values using the sif_status structs.
import csv
dfpd_infile = “hang_pipe2.csv”
  def generate_path_force (line): #only for sifs we are hanging
  unit = line[“unit”]
  split_data = line[“SIF name”].split(“_”)
  data ‘ ‘_’.join(split_data[2:])
  unit_macro = “′VDEBOX_” + unit + “UNIT_HIER”
  Path = unit_macro + “.” + line[“Path of SIF”]
```

### Data Processing and Analysis/ML Model

A total of 472 data points were collected by running a variety of tests on the pipeline. Data was then meticulously inspected for coherence and interpretability, before getting fed to a machine learning model for training and inference.

The data collected was then processed and used for training and inference. A data processing and ML model Python® script was used, with Scikit-Learn as the ML package. The data was then split into 80%/20% where 80% of the data was used for training, and 20% was used for testing. The following portion of a pseudo code was used to establish the machine learning model.

```
def RandomForest (x, y):
  # Split data into training and testing datasets
  #Assume 80%/20% split for training/testing is followed
  X_train, x_test, y_train, y_test = train_test_split(x, y, test_size=0.2, random_state=42)
  Print(“y_train”, y_train)
  Print(“y_test”, y_test)
  # Create a Random Forest classifier
  #rf_classifier = RandomForestClassifier(n_estimators=100, *, criterion=’gini’,
  max_depth=None, min_samples=XXX),
  rf_classifier = RandomForestClassifier(n_estimators=1)
  # Train the classifier on the training data
  rf_classifier.fit(x_train, y_train)
  # Make predictions on the test data
  Y_pred = rf_classifier.predict(X_test)
  # Calculate the accuracy of the classifier
  accuracy = accuracy_score(y_test, y_pred)
  print(f*Accuracy: {accuracy: .2f}”)
  # save the model to disk
  filename = ‘RF.sav’
  joblib.dump(rf_classifier, filename)
  return rf_classifier
```

The tests achieved satisfactory prediction accuracies with Random Forests and KNN classifiers (Table 2).

TABLE 2
Prediction Accuracies of the ML Hang Classification Models

| | Hanged Unit | Hanged SIF |
|---|---|---|
| | Prediction | Prediction |
| ML Model | Accuracy | Accuracy |
| Random Forest | 97% | 68% |
| K- Nearest Neighbors (KNN) | 95% | 60% |

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation of firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that a logic unit also may utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality. Component herein also may refer to processors and other specific hardware devices.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

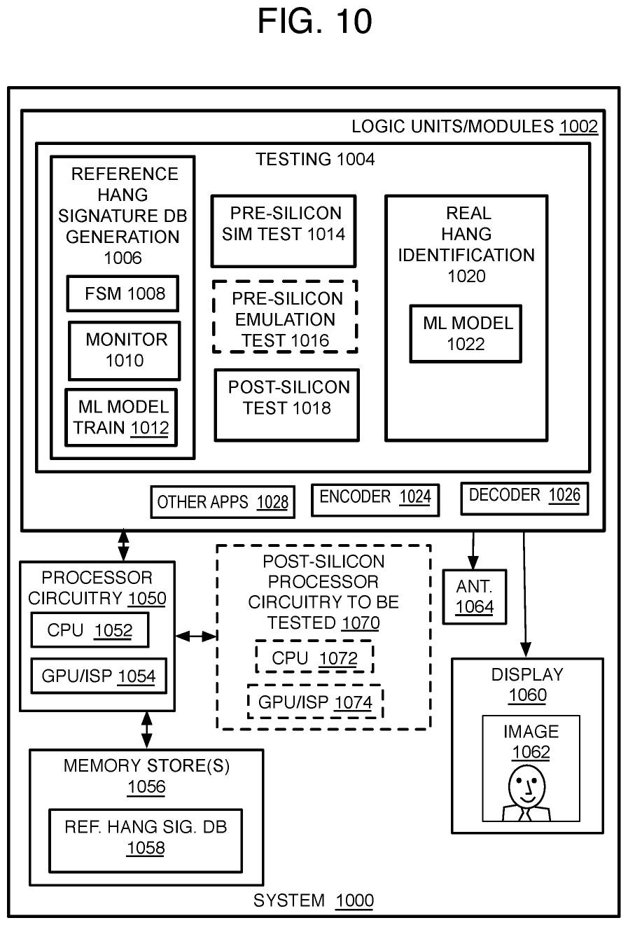

Referring to FIG. 10, an example system 1000 is provided for hang classification in accordance with at least some implementations of the present disclosure. As shown in FIG. 10, system 1000 may include processor(s) formed by processor circuitry 1050 which may include a CPU 1052 and/or one or more image signal processors (ISP) or GPUs 1054, and a memory store(s) 1056. The processor circuitry 1050 may run the RTL and other debugging software to perform pre-silicon testing. Otherwise, post-silicon processor circuitry 1070 to be tested also may be part of the system 1000.

Also as shown, system 1000 may have logic units or modules 1002 including a testing or debugging unit 1004. The testing unit 1004 may have a reference hang signature DB generation unit 1006 with an FSM 1008, a monitor unit 1010, and an ML model training unit 1012. The testing unit 1004 also may have a pre-silicon simulation test unit 1014, a pre-silicon emulation test unit 1016, and/or a post-silicon test unit 1018. A real (or hidden) hang identification unit 1020 is proceeded as well and may have an ML model 1022 similar or the same as ML model 242 described above. An encoder 1024, decoder 1026, as well other applications 1028 that can be run on processor circuitry 1050 also may be part of logic units 1002. Logic units 1002 also may have an antenna 1064 for transmitting or receiving image data, and a display 1060 with a screen capable of showing an image 1062. The names of the units herein for system 1000 may have the same or similar names to that of devices described above, and in turn have the same or similar functions.

In some examples, one or more or portions of the operations of processes with flow 300 and 900 may be implemented via ISP 1054. In other examples, one or more or portions of the operations are implemented via a central processor 1052 forming processor(s) of processor circuitry 1050, an image processing unit, an image processing pipeline, an image signal processor 1054, or the like. In some examples, one or more or portions or operations are implemented in hardware as a system-on-a-chip (SoC) or other specific purpose hardware or other shared hardware. In some examples, one or more or portions of the operations are implemented in hardware via a field programmable gate array (FPGA). The post-silicon processor circuitry structure 1070 to be tested may have the same or similar circuitry with one or more CPUs 1072 and one or more GPUs/ISPs 1074 or other types of circuits, chips, and so forth.

Processor circuitry 1050, CPU 1052, and image signal processor 1054 may include any number and type of image or graphics processing units that may provide the operations as discussed herein. Such operations may be implemented via software or hardware or a combination thereof. For example, image signal processor 1054 may include circuitry dedicated to manipulate and/or analyze debug testing data including hang related data. By one form, memory 1056 may hold the reference hang signature database 1058 described above. Central processor 1052 may include any number and type of processing units or modules that may provide control and other high level functions for system 1000 and/or provide any operations as discussed herein. The processor circuitry 1070 can have the same or similar features.

Memory 1056 may be any type of memory such as volatile memory (e.g., Static Random Access Memory (SRAM), Dynamic Random Access Memory (DRAM), etc.) or non-volatile memory (e.g., hard drives, flash memory, etc.), and so forth. In a non-limiting example, memory 1056 may be implemented by cache memory.

In an implementation, one or more or portions of the hang classification testing systems or devices are implemented via an execution unit (EU) of processor circuitry 1050. The EU may include, for example, programmable logic or circuitry such as a logic core or cores that may provide a wide array of programmable logic functions. In an implementation, one or more or portions of the hang classification operations or data are implemented via dedicated hardware such as fixed function circuitry or the like. Fixed function circuitry may include dedicated logic or circuitry and may provide a set of fixed function entry points that may map to the dedicated logic for a fixed purpose or function.

Various components of the systems described herein may be implemented in software, firmware, and/or hardware and/or any combination thereof. For example, various components of the devices or systems discussed herein may be provided, at least in part, by hardware of a computing System-on-a-Chip (SoC) such as may be found in a computing system such as, for example, a smart phone or camera array. Those skilled in the art may recognize that systems described herein may include additional components that have not been depicted in the corresponding figures. For example, the systems discussed herein may include additional components that have not been depicted in the interest of clarity.

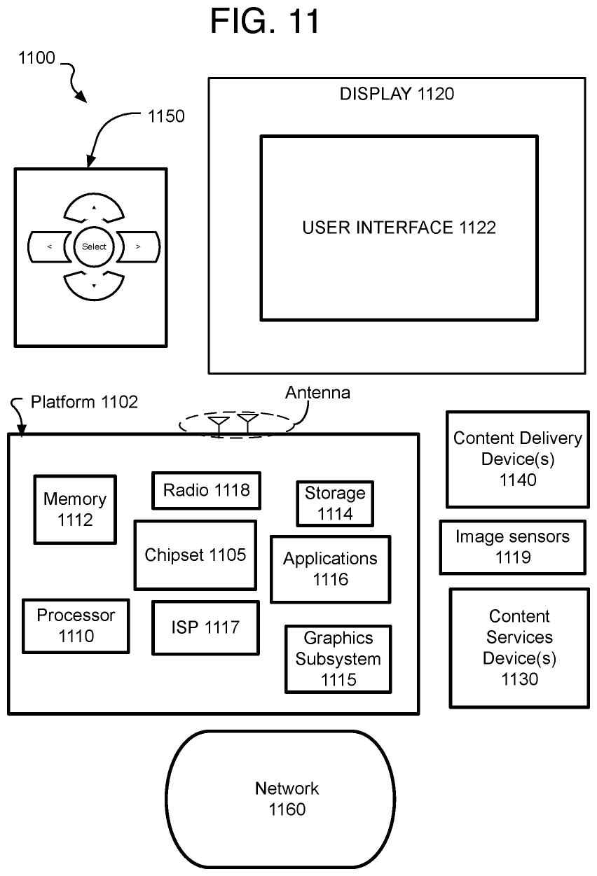

Referring to FIG. 11, an example system 1100 is arranged in accordance with at least some implementations of the present disclosure. In various implementations, system 1100 may be a mobile device system although system 1100 is not limited to this context. For example, system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), a surveillance camera, a surveillance system including a camera, and so forth. Otherwise, at least part of system 1100 may be on one or more servers.

In various implementations, system 1100 includes a platform 1102 coupled to a display 1120. Platform 1102 may receive content from a content device such as content services device(s) 1130 or content delivery device(s) 1140 or other content sources such as image sensors 1119. For example, platform 1102 may receive image data as discussed herein from image sensors 1119 or any other content source. A navigation controller 1150 including one or more navigation features may be used to interact with, for example, platform 1102 and/or display 1120. Each of these components is described in greater detail below.

In various implementations, platform 1102 may include any combination of a chipset 1105, processor 1110, memory 1112, antenna, storage 1114, graphics subsystem 1115, applications 1116, image signal processor 1117 and/or radio 1118. Chipset 1105 may provide intercommunication among processor 1110, memory 1112, storage 1114, graphics subsystem 1115, applications 1116, image signal processor 1117 and/or radio 1118. For example, chipset 1105 may include a storage adapter (not depicted) capable of providing intercommunication with storage 1114.

Processor 1110 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1114 may include technology to increase the storage performance enhanced protection for valuable digital media when multiple hard drives are included, for example.

Image signal processor 1117 may be implemented as a specialized digital signal processor or the like used for image processing. In some examples, image signal processor 1117 may be implemented based on a single instruction multiple data or multiple instruction multiple data architecture or the like. In some examples, image signal processor 1117 may be characterized as a media processor. As discussed herein, image signal processor 1117 may be implemented based on a system on a chip architecture and/or based on a multi-core architecture.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, DisplayPort, wireless HDMI, and/or wireless HD compliant techniques. Graphics subsystem 1115 may be integrated into processor 1110 or chipset 1105. In some implementations, graphics subsystem 1115 may be a stand-alone device communicatively coupled to chipset 1105.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120. Platform 1102 and/or content services device(s) 1130 may be coupled to a network 1160 to communicate (e.g., send and/or receive) media information to and from network 1160. Content delivery device(s) 1140 also may be coupled to platform 1102 and/or to display 1120.

Image sensors 1119 may include any suitable image sensors that may provide image data based on a scene. For example, image sensors 1119 may include a semiconductor charge coupled device (CCD) based sensor, a complimentary metal-oxide-semiconductor (CMOS) based sensor, an N-type metal-oxide-semiconductor (NMOS) based sensor, or the like. For example, image sensors 1119 may include any device that may detect information of a scene to generate image data.

In various implementations, content services device(s) 1130 may include a cable television box, personal computer, network, telephone, Internet enabled devices or appliance capable of delivering digital information and/or content, and any other similar device capable of uni-directionally or bi-directionally communicating content between content providers and platform 1102 and/display 1120, via network 1160 or directly. It will be appreciated that the content may be communicated uni-directionally and/or bi-directionally to and from any one of the components in system 1100 and a content provider via network 1160. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of navigation controller 1150 may be used to interact with user interface 1122, for example. In various implementations, navigation controller 1150 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1150 may be replicated on a display (e.g., display 1120) by movements of a pointer, cursor, focus ring, or other visual indicators displayed on the display. For example, under the control of software applications 1116, the navigation features located on navigation controller 1150 may be mapped to virtual navigation features displayed on user interface 1122, for example. In various implementations, navigation controller 1150 may not be a separate component but may be integrated into platform 1102 and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example. Program logic may allow platform 1102 to stream content to media adaptors or other content services device(s) 1130 or content delivery device(s) 1140 even when the platform is turned “off.” In addition, chipset 1105 may include hardware and/or software support for 5.1 surround sound audio and/or high definition 7.1 surround sound audio, for example. Drivers may include a graphics driver for integrated graphics platforms. In various implementations, the graphics driver may comprise a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various implementations, platform 1102 and display 1120 may be an integrated unit. Display 1120 and content service device(s) 1130 may be integrated, or display 1120 and content delivery device(s) 1140 may be integrated, for example. These examples are not meant to limit the present disclosure.

In various implementations, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 11.

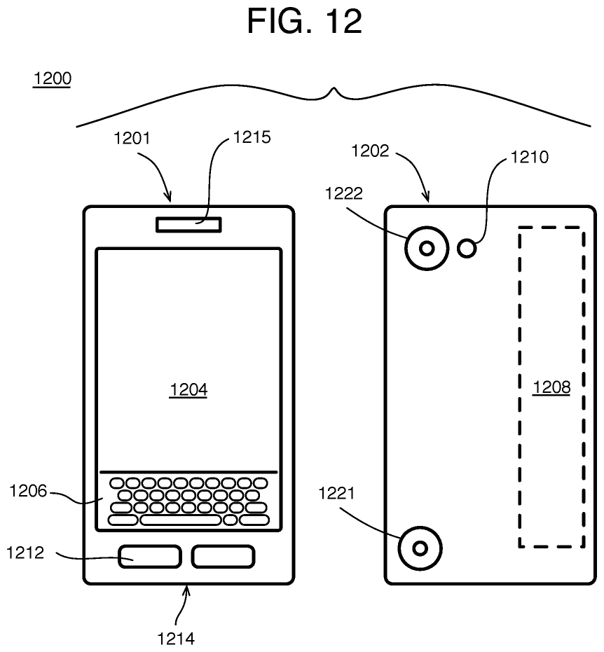

As described above, system 1100 may be embodied in varying physical styles or form factors. FIG. 12 illustrates an example small form factor device 1200, arranged in accordance with at least some implementations of the present disclosure. In some examples, system 1000 or 1100 may be implemented via device 1200. In other examples, other systems, components, or modules discussed herein or portions thereof may be implemented via device 1200. In various implementations, for example, device 1200 may be implemented as a mobile computing device having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smartphone, smart tablet or smart mobile television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be implemented by a motor vehicle or robot, or worn by a person, such as wrist computers, finger computers, ring computers, eyeglass computers, belt-clip computers, arm-band computers, shoe computers, clothing computers, and other wearable computers. In various implementations, for example, a mobile computing device may be implemented as a smartphone capable of executing computer applications, as well as voice communications and/or data communications. Although some implementations may be described with a mobile computing device implemented as a smartphone by way of example, it may be appreciated that other implementations may be implemented using other wireless mobile computing devices as well. The implementations are not limited in this context.

As shown in FIG. 12, device 1200 may include a housing with a front 1201 and a back 1202. Device 1200 includes a display 1204, an input/output (I/O) device 1206, a camera 1221, a camera 1222, and an integrated antenna 1208. In some implementations, device 1200 does not include cameras 1221 and 1222, and device 1200 attains input image data (e.g., any input image data discussed herein) from another device. Device 1200 also may include navigation features 1212. I/O device 1206 may include any suitable I/O device for entering information into a mobile computing device. Examples for I/O device 1206 may include an alphanumeric keyboard, a numeric keypad, a touch pad, input keys, buttons, switches, microphones 1214, speakers 1215, voice recognition device and software, and so forth. Information also may be entered into device 1200 by way of microphone (not shown), or may be digitized by a voice recognition device. As shown, device 1200 may include cameras 1221, 1222, and a flash 1210 integrated into back 1202 (or elsewhere) of device 1200. In other examples, cameras 1221, 1222, and flash 1210 may be integrated into front 1201 of device 1200 or both front and back sets of cameras may be provided.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

By an example 1, a computer-implemented method comprises injecting a hang of data transfer on at least one of a plurality of interfaces interconnecting simulated or emulated hardware subcomponents arranged to send or receive data transmitted between the subcomponents; determining activity status of data transfer at the interfaces; and generating a hang signature to be placed in a hang signature database, wherein the hang signature indicates the activity status of the interfaces that occur when the hang is present and identification of the hardware subcomponent with the hang.

By an example 2, the subject matter of example 1, wherein the method comprises generating multiple hang signatures, wherein each hang of a different hang signature is at a different one of the interfaces, has a different workload on one or more of the subcomponents, has different input values at one or more of the subcomponents, or any combination of these.

By an example 3, the subject matter of example 1 or 2, wherein the hang signature comprises a code indicating the activity status values of the plurality of interfaces.

By an example 4, the subject matter of any one of examples 1 to 3, wherein placement of the hang signature in a specific field of the hang signature database indicates which interface has the hang associated with the hang signature.

By an example 5, the subject matter of any one of examples 1 to 4, wherein each interface is either a sender interface or a receiver interface both respectively at interconnected pairs of the subcomponents, and wherein available activity statuses include indicator codes for stall wherein the receiver is not ready to receive data when the sender has data to send, starve wherein the sender is not ready to transfer data and the receiver is ready to receive data, idle wherein both the sender and receiver are unready to transfer data, and active wherein either the sender and receiver are ready to transfer data or data is being transferred from sender to receiver.

By an example 6, the subject matter of any one of examples 1 to 5, wherein injecting the hang comprises injecting a hang on at least one interface of at least one intermediate subcomponent, wherein the subcomponents include a series of the subcomponents to perform a computer-related function and having an input subcomponent, an output subcomponent, and the at least one intermediate subcomponent between the input and output subcomponents.

By an example 7, the subject matter of any one of examples 1 to 6, wherein injecting the hang comprises applying a back pressure stall at a receiver interface at a receiver subcomponent, wherein the stall is applied until the interfaces being tested all have a starve state, stall state, or idle state.

By an example 8, the subject matter of example 7, wherein the stall is arranged to be applied while the receiver subcomponent is receiving transmitted data from a sender interface at a sender subcomponent.

By an example 9, the subject matter of example 7, wherein a duration of the stall is randomized.

By an example 10, the subject matter of any one of examples 1 to 9, wherein the determining is performed after the interfaces being tested are in a steady state.

By an example 11, the subject matter of any one of examples 1 to 10, wherein the injecting comprises modifying at least one interface control signal of at least one interface to force a stall state at a receiver interface or a starve state at a sender interface.

By an example 12, the subject matter of any one of examples 1 to 11, wherein the hang signature is a reference hang signature, and wherein the method comprises detecting a location of a hang comprising receiving activity statuses of the interfaces, generating a hidden hang signature, and using a machine learning algorithm to compare the hidden hang signature to reference hang signatures in a reference hang signature database, and to generate an identification of one of the interfaces as having a hang when a hang exists.

By an example 13, a computer-implemented system comprises a data processing device having simulated, emulated, or physical hardware subcomponents and a plurality of interfaces each being arranged to transfer data between at least two of the subcomponents; memory storing reference hang signatures, wherein each reference hang signature indicates which interface caused a hang of data transfer associated with at least one of the interfaces and activity status indicator values of the plurality of interfaces that occur when the hang is present; and processor circuitry communicatively coupled to the memory and the interfaces, and being arranged to operate by: receiving activity status indicators indicating a status of data transfer at the interfaces; generating a hidden hang signature using the activity status indicators; and comparing the hidden hang signature to the reference hang signatures to determine whether a hang exists and an identification of a subcomponent that caused the hang.

By an example 14, the subject matter of example 13, wherein the comparing comprises using a machine learning model to output an identification of a most-likely subcomponent causing the hang.

By an example 15, the subject matter of example 14, wherein the machine learning model comprises at least one of a machine learning decision tree, K-nearest neighbors (KNN) classifier, or random forests algorithm.

By an example 16, the subject matter of example 14, wherein the machine learning model determines a most-likely subcomponent of the hang even when the hidden hang signature is different in one or more values to all of the reference hang signatures.

By an example 17, the subject matter of example 14, wherein the processor circuitry is arranged to operate by training the machine learning model comprising varying the interface with the hang, a workload being processed by the subcomponents, and the data values input to the subcomponents.

By an example 18, at least one article comprising at least one computer-readable medium having instructions thereon that when read, cause a computing device to operate by: injecting a hang of data transfer on at least one of a plurality of interfaces interconnecting simulated or emulated hardware subcomponents arranged to send or receive data transmitted between the subcomponents; determining activity status of data transfer at the interfaces; and generating a hang signature to be placed in a hang signature database, wherein the hang signature indicates the activity status of the interfaces that occur when the hang is present and identification of the hardware subcomponent with the hang.

By an example 19, the subject matter of examples 18, wherein the injecting includes modifying data validation (DV)-hold interface control codes that indicate a status of DV-hold interfaces or a status of credit-release interfaces.

By an example 20, the subject matter of example 18 or 19, 2, wherein the instructions cause the computing device to operate by performing local recovery solely on the subcomponent with the hang.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method, comprising:
injecting a hang of data transfer on at least one of a plurality of interfaces interconnecting simulated or emulated hardware subcomponents arranged to send or receive data transmitted between the subcomponents;
determining activity status of data transfer at the interfaces; and
generating a hang signature to be placed in a hang signature database, wherein the hang signature indicates the activity status of the interfaces that occur when the hang is present and identification of the hardware subcomponent with the hang.

2. The method of claim 1, comprising generating multiple hang signatures, wherein each hang of a different hang signature is at a different one of the interfaces, has a different workload on one or more of the subcomponents, has different input values at one or more of the subcomponents, or any combination of these.

3. The method of claim 1, wherein the hang signature comprises a code indicating the activity status values of the plurality of interfaces.

4. The method of claim 1, wherein placement of the hang signature in a specific field of the hang signature database indicates which interface has the hang associated with the hang signature.

5. The method of claim 1, wherein each interface is either a sender interface or a receiver interface both respectively at interconnected pairs of the subcomponents, and wherein available activity statuses include indicator codes for stall wherein the receiver is not ready to receive data when the sender has data to send, starve wherein the sender is not ready to transfer data and the receiver is ready to receive data, idle wherein both the sender and receiver are unready to transfer data, and active wherein either the sender and receiver are ready to transfer data or data is being transferred from sender to receiver.

6. The method of claim 1, wherein injecting the hang comprises injecting a hang on at least one interface of at least one intermediate subcomponent, wherein the subcomponents include a series of the subcomponents to perform a computer-related function and having an input subcomponent, an output subcomponent, and the at least one intermediate subcomponent between the input and output subcomponents.

7. The method of claim 1, wherein injecting the hang comprises applying a back pressure stall at a receiver interface at a receiver subcomponent, wherein the stall is applied until the interfaces being tested all have a starve state, stall state, or idle state.

8. The method of claim 7, wherein the stall is arranged to be applied while the receiver subcomponent is receiving transmitted data from a sender interface at a sender subcomponent.

9. The method of claim 7, wherein a duration of the stall is randomized.

10. The method of claim 1, wherein the determining is performed after the interfaces being tested are in a steady state.

11. The method of claim 1, wherein the injecting comprises modifying at least one interface control signal of at least one interface to force a stall state at a receiver interface or a starve state at a sender interface.

12. The method of claim 1, wherein the hang signature is a reference hang signature, and wherein the method comprises detecting a location of a hang comprising receiving activity statuses of the interfaces, generating a hidden hang signature, and using a machine learning algorithm to compare the hidden hang signature to reference hang signatures in a reference hang signature database, and to generate an identification of one of the interfaces as having a hang when a hang exists.

13. A computer-implemented system, comprising:
a data processing device having simulated, emulated, or physical hardware subcomponents and a plurality of interfaces each being arranged to transfer data between at least two of the subcomponents;
memory storing reference hang signatures, wherein each reference hang signature indicates which interface caused a hang of data transfer associated with at least one of the interfaces and activity status indicator values of the plurality of interfaces that occur when the hang is present; and
processor circuitry communicatively coupled to the memory and the interfaces, and being arranged to operate by:
receiving activity status indicators indicating a status of data transfer at the interfaces;
generating a hidden hang signature using the activity status indicators; and
comparing the hidden hang signature to the reference hang signatures to determine whether a hang exists and an identification of a subcomponent that caused the hang.

14. The system of claim 13, wherein the comparing comprises using a machine learning model to output an identification of a most-likely subcomponent causing the hang.

15. The system of claim 14, wherein the machine learning model comprises at least one of a machine learning decision tree, K-nearest neighbors (KNN) classifier, or random forests algorithm.

16. The system of claim 14, wherein the machine learning model determines a most-likely subcomponent of the hang even when the hidden hang signature is different in one or more values to all of the reference hang signatures.

17. The system of claim 14, wherein the processor circuitry is arranged to operate by training the machine learning model comprising varying the interface with the hang, a workload being processed by the subcomponents, and the data values input to the subcomponents.

18. At least one article comprising at least one computer-readable medium having instructions thereon that when read, cause a computing device to operate by:
injecting a hang of data transfer on at least one of a plurality of interfaces interconnecting simulated or emulated hardware subcomponents arranged to send or receive data transmitted between the subcomponents;
determining activity status of data transfer at the interfaces; and
generating a hang signature to be placed in a hang signature database, wherein the hang signature indicates the activity status of the interfaces that occur when the hang is present and identification of the hardware subcomponent with the hang.

19. The article of claim 18, wherein the injecting includes modifying data validation (DV)-hold interface control codes that indicate a status of DV-hold interfaces or a status of credit-release interfaces.

20. The article of claim 18, wherein the instructions cause the computing device to operate by performing local recovery solely on the subcomponent with the hang.
